(19) United States
(12) Patent Application Publication
(10) Pub. No.: US 2021/0377683 A1
(43) Pub. Date: Dec. 2, 2021

(54) Pressure-retaining Automata for Voice-operated Motherboard Adhesive and SR

(71) Applicant: Innovation Sound Technology Co., Ltd., Shenzhen, Guangdong (CN)

(72) Inventors: Shun Ming Yuen, Shenzhen, Guangdong (CN); Qingshan Tang, Shenzhen, Guangdong (CN); Xinbing Wang, Shenzhen, Guangdong (CN)

(21) Appl. No.: 17/256,223

(22) PCT Filed: Nov. 11, 2019
(86) PCT No.: PCT/CN2019/117139

§ 371 Date: Dec. 27, 2020

(30) Foreign Application Priority Data
Nov. 8, 2019 (CN) 201911085155.9

(51) Int. Cl. H04R 31/00; B32B 37/10; B32B 37/12; B32B 38/18

(52) U.S. Cl. CPC H04R 31/006; B32B 38/1833; B32B 37/12; B32B 37/10

(57) ABSTRACT

The invention belongs to the technical field of automatic equipment for pressure retention of earphone voice-operated motherboard adhesive and SR, and discloses a pressure-retaining automata for voice-operated motherboard adhesive and SR, which consists of a rack, an independent belt module arranged on the rack, opposite sensors fixed on each belt module, a guide module set on the belt module, and a stop module disposed on the guide module. The invention realizes high automation and high positioning accuracy.

### FIELD OF THE INVENTION

The invention relates to the technical field of automatic pressure-retaining equipment, in particular to a pressure-retaining automata for voice-operated motherboard adhesive and SR.

### BACKGROUND OF THE INVENTION

The traditional pressure retention is mainly done by manual operation with low work efficiency. The adhesive and SR traditional pressure needs to be carried out in two separate stations, which requires high labor costs. Moreover, the manual operation method is prone to deviation, resulting in poor pressure holding, poor product effect, and low rates of finished products. In the traditional pressure retention, the pressure-retaining plane cannot be guaranteed to be uniform in most cases, leading to a high scrappage. In addition, the operators frequently put their hands under the pressure head, causing heavy mental stress and work-related injuries.

### DESCRIPTION OF THE INVENTION

The present invention is intended to overcome the existing defects by providing a pressure-retaining automata for voice-operated motherboard adhesive and SR. By setting up independent belts for feeding, the sensitive sensors control the product movement and the blocking module plays a part of interception. During the whole movement process, there is no overlapping of materials or collision between two products, and the pressure retention of products is completely done under the condition of positioning by the guide module, thus realizing automatic product feeding, automatic pressure retention, and has the characteristics of high automation, high positioning accuracy, high work efficiency, good product effects, and low production costs. It is convenient, simple and fast to use, and can effectively solve the problems in the background technology.

In order to solve the above technical problems, the present invention provides the following technical solutions:

The invention provides a pressure-retaining automata for voice-operated motherboard adhesive and SR, which consists of:

A rack; and

A belt line module disposed on the rack; and

No. 1 sensor set on the belt line module to sense products; and

No. 2 sensor set on the belt line module to sense the first segment of products in place; and

No. 3 sensor set on the belt line module to sense products separating from the first segment; and

No. 4 sensor set on the belt line module to sense the second segment of products in place; and

No. 5 sensor set on the belt line module to sense products separating from the second segment; and

No. 6 sensor set on the belt line module to sense the third segment of products in place; and

No. 7 sensor set on the belt line module to sense products separating from the third segment; and

No. 8 sensor set on the belt line module to sense the fourth segment of products in place; and

No. 1 stop module disposed on rack; and

No. 2 stop module disposed on rack; and

No. 3 stop module disposed on rack; and

No. 1 pressure-retaining module disposed on rack; and

No. 2 pressure-retaining module disposed on rack; and

No. 1 guide module arranged on the rack and located below No. 1 pressure-retaining module; and

No. 2 guide module arranged on the rack and located below No. 2 pressure-retaining module; and

A man-machine interface set on the rack.

As a preferred technical solution of the present invention, the No. 1 pressure-retaining module is also installed with No. 1 pressure gauge for pressure retention monitoring, and No. 2 pressure-retaining module is also equipped with No. 2 pressure gauge for pressure retention monitoring.

As a preferred technical solution of the present invention, the man-machine interface is equipped with a monochromatic lamp for alarm display.

As a preferred technical solution of the present invention, pressure-retaining automata for voice-operated motherboard adhesive and SR further comprises:

A motor, fixed to the upper part of the rack;

A belt, one end of which is connected to the output end of the motor;

A driving shaft, one end of which is connected with the other end of the belt, so that the motor drives the driving shaft through the belt;

Wherein, the driving shaft is connected with the belt line module.

As a preferred technical solution of the present invention, pressure-retaining automata for voice-operated motherboard adhesive and SR further comprises:

No. 1 guide module and No. 2 guide module, disposed on the upper part of belt line module,

Wherein, the No. 1 guide module and No. 2 guide module are both connected to the cylinder.

As a preferred technical solution of the present invention, pressure-retaining automata for voice-operated motherboard adhesive and SR further comprises:

A cooling fan, arranged on the upper part of the rack.

One or a plurality of technical solutions provided in the present invention has at least the following technical effects or advantages:

By setting up independent belts for feeding, the sensitive sensors control the product movement and the blocking module plays a part of interception. During the whole movement process, there is no overlapping of materials or collision between two products, and the pressure retention of products is completely done under the condition of positioning by the guide module, thus realizing automatic product feeding, automatic pressure retention, and has the characteristics of high automation, high positioning accuracy, high work efficiency, good product effects, and low production costs. It is convenient, simple and fast to use

### BRIEF INTRODUCTION OF THE DRAWINGS

The accompanying drawings are used to provide a further understanding of the present invention, and constitute a part of the specification. Together with the embodiments of the present invention, they are used to explain the present invention but shall not constitute a limitation to the present invention.

In the accompanying drawings:

FIG. 1 and FIG. 2 are three-dimensional views of a pressure-retaining automata for voice-operated motherboard adhesive and SR according to an embodiment of the present invention;

FIG. 3, FIG. 4, and FIG. 5 are partial structural schematic views of a pressure-retaining automata for voice-operated motherboard adhesive and SR according to an embodiment of the present invention;

FIG. 6 to FIG. 16 are enlarged views of locations A to K of the upper part of a pressure-retaining automata for voice-operated motherboard adhesive and SR according to an embodiment of the present invention;

Numbers in the drawings: 10, rack; 11, cooling fan; 20, belt line module; 21, No. 1 sensor; 22, second sensor; 23, No. 3 sensor; 24, No. 4 sensor; 25, No. 5 sensor; 26, No. 6 sensor; 27, No. 7 sensor; 28, No. 8 sensor; 30, No. 1 stop module; 31, No. 2 stop module; 33, No. 3 stop module; 40, No. 1 pressure-retaining module; 41, No. 1 pressure gauge; 42, No. 2 pressure-retaining module; 43, No. 2 pressure gauge; 50, No. 1 guide module; 51, No. 2 guide module; 60, touch screen; 61, monochrome lamp; 7, motor; 72, belt; 73, driving shaft.

### DETAILED DESCRIPTION OF THE PREFERRED EMBODIMENTS

In order to make the objectives, technical solutions and advantages of the present invention clearer, further descriptions are presented below on the invention in detail with reference to the accompanying drawings and embodiments. It shall be understood that the specific embodiments described herein are only used to interpret the present invention, but not to limit the present invention.

It shall be noted that when an element is referred to as being “fixed to” or “disposed on” another element, it may be directly on the other element or indirectly on the other element. When an element is said to be “connected to” another element, it may be directly connected to the other element or indirectly connected to the other element.

In the description of the present invention, it shall be understood that the orientation or positional relationship indicated by the terms such as “length”, “width”, “upper”, “lower”, “front”, “rear”, “left”, “right”, “vertical”, “horizontal”, “top”, “bottom”, “inside”, “outside” are based on the orientation or positional relationship shown in the drawings, which are only for the convenience of describing the present invention and simplifying the description, rather than indicate or imply that the specified device or element must have a specific orientation, or must be constructed and operated in a specific orientation. Therefore, it shall not be understood as a limitation on the present invention.

In addition, the terms “No. 1” and “No. 2” are only used for descriptive purposes, and shall not be understood as indicating or implying relative importance or implicitly indicating the number of specified technical features. Hence, the features defined with “No. 1” and “No. 2” may explicitly or implicitly include one or a plurality of these features. In the description of the present invention, “a plurality of” means two or more than two, unless otherwise specifically defined.

To better understand the above technical solutions, the above technical solutions will be described in detail below in conjunction with the drawings to the specification and specific implementations.

### Embodiments 1

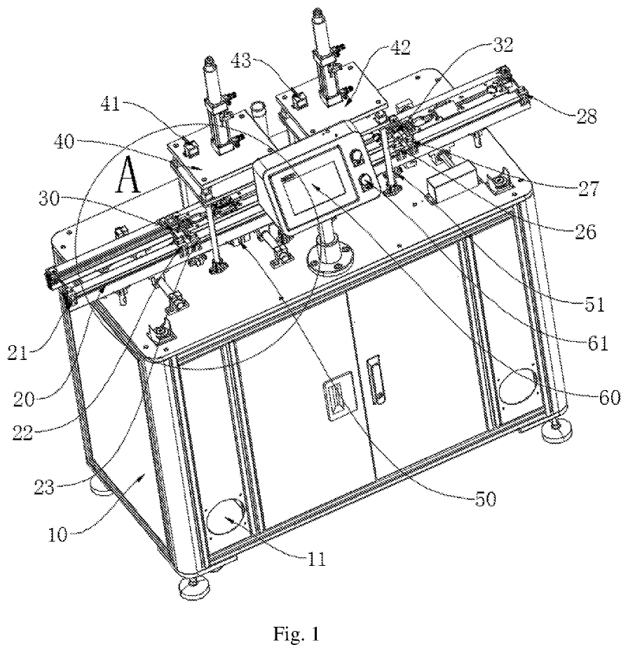

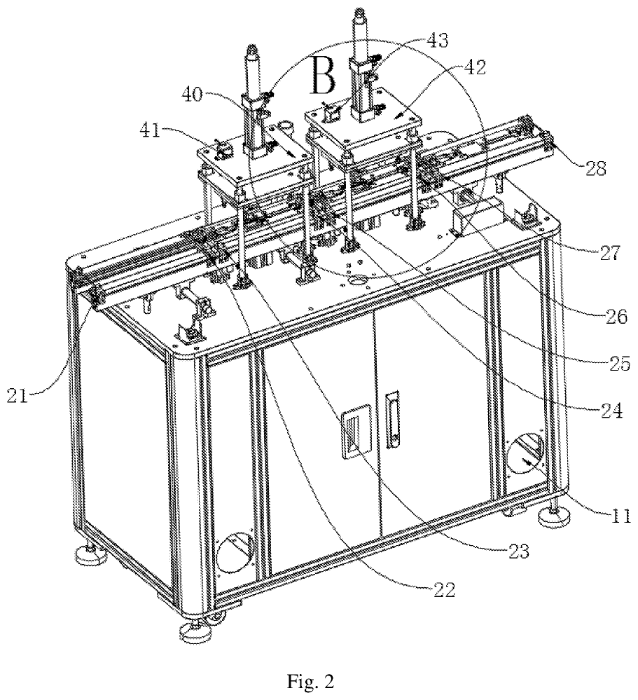

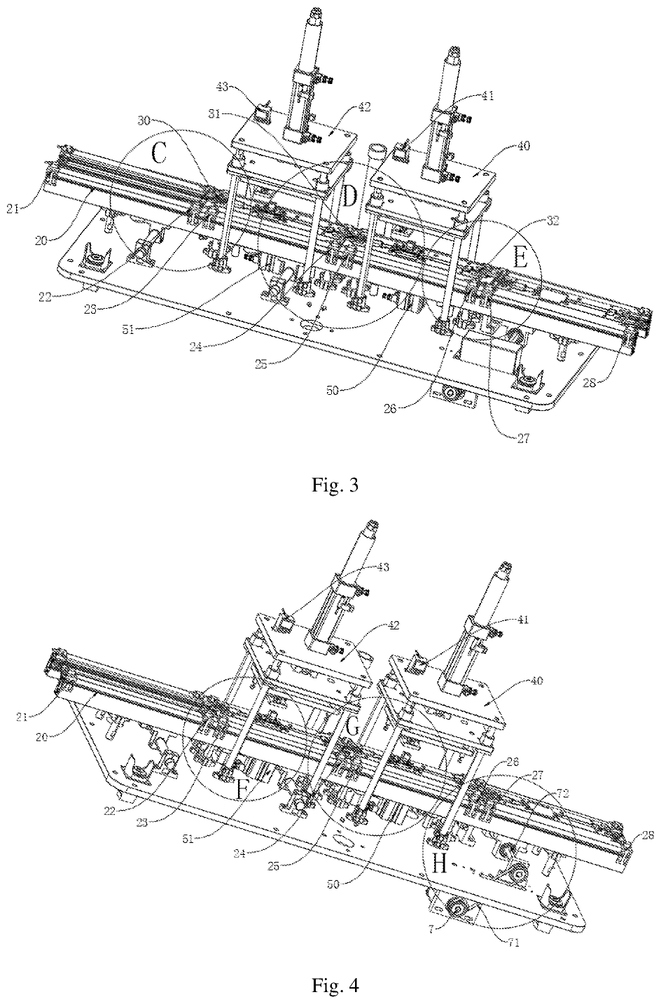

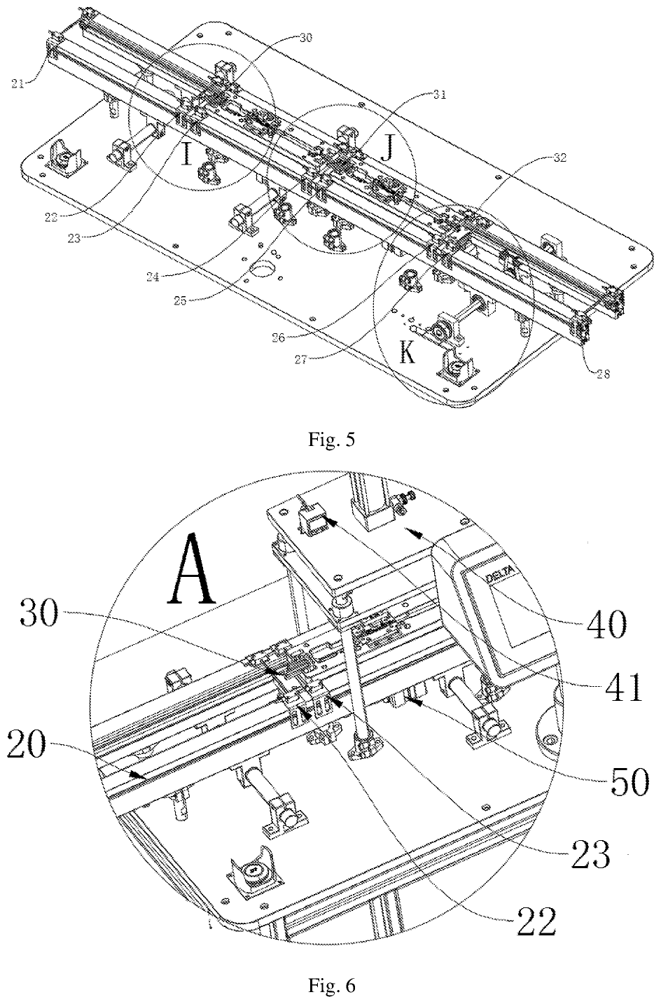

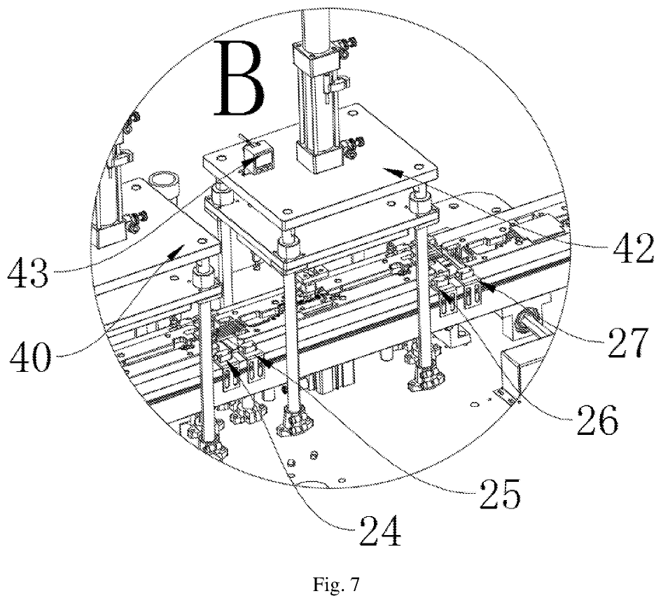

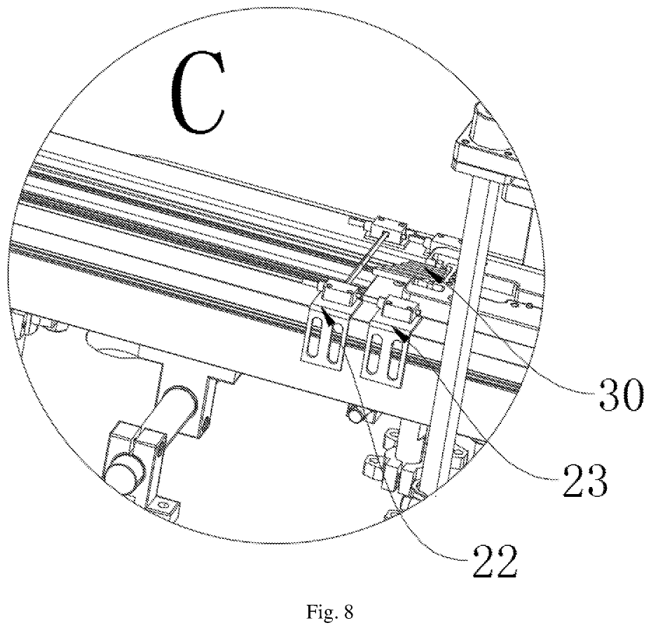

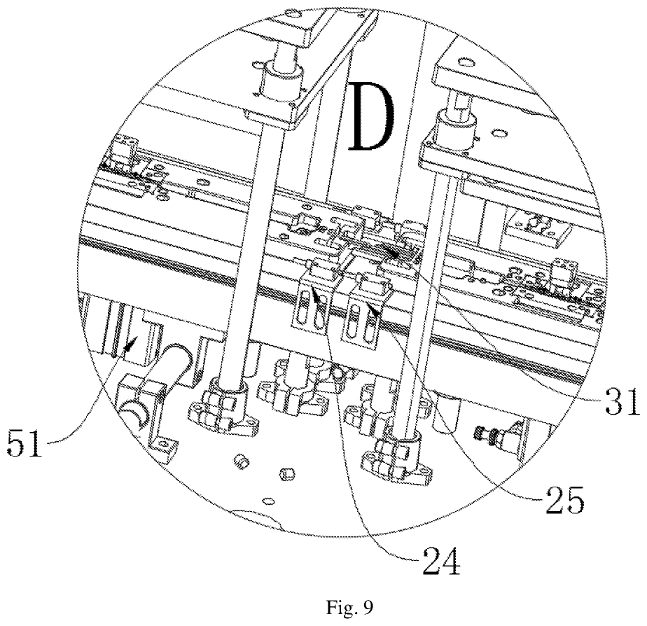

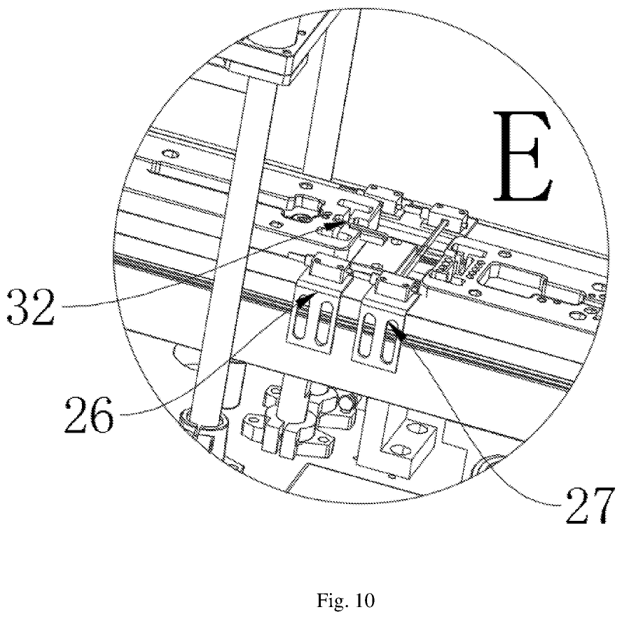

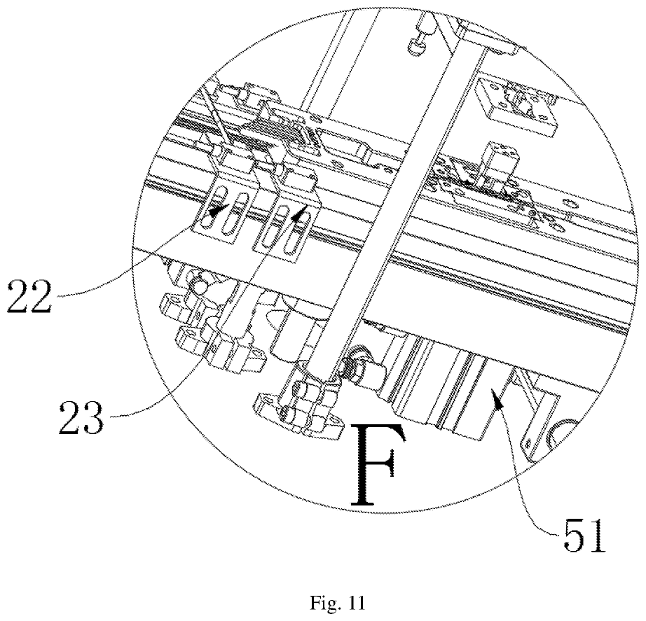

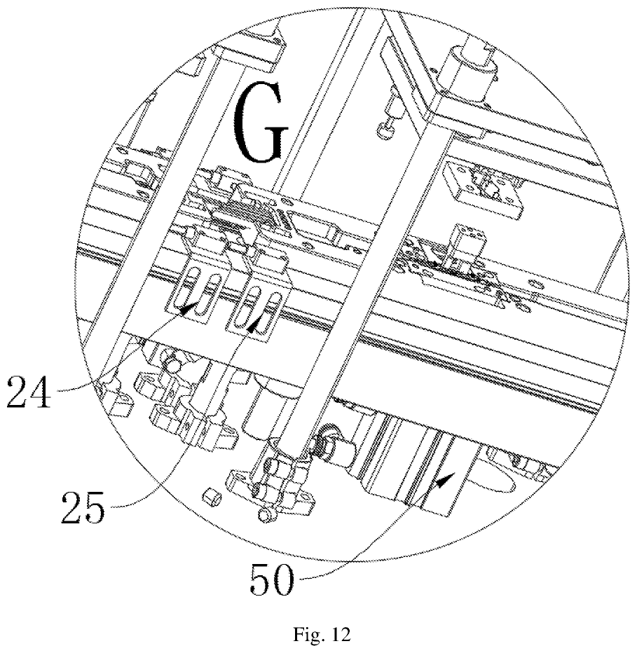

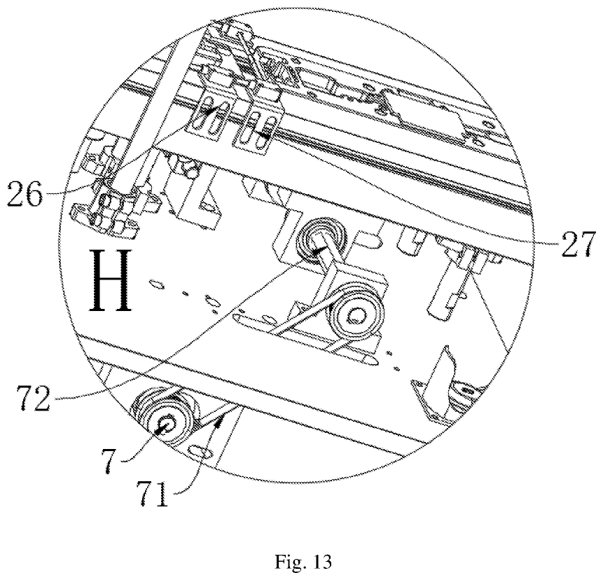

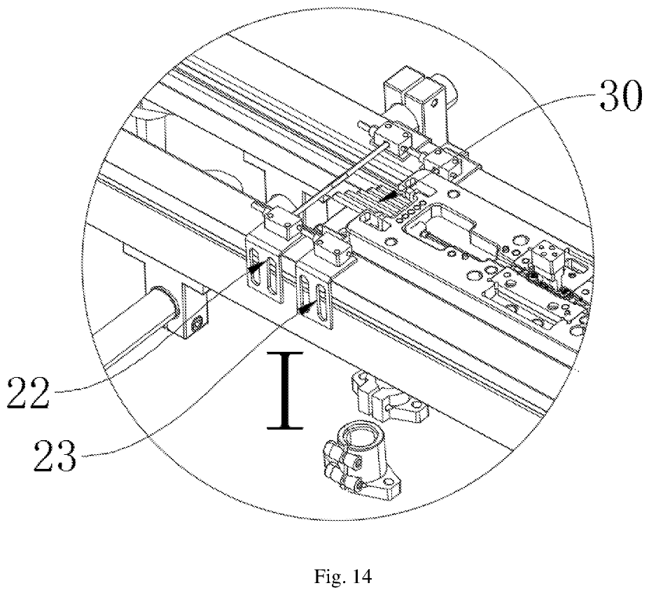

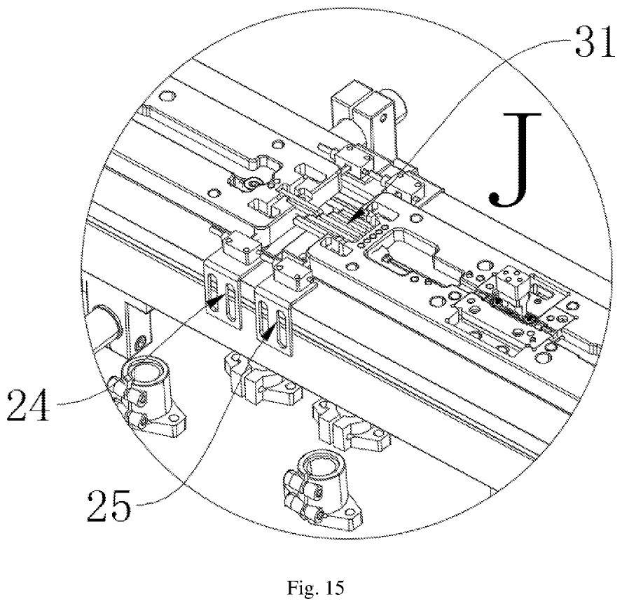

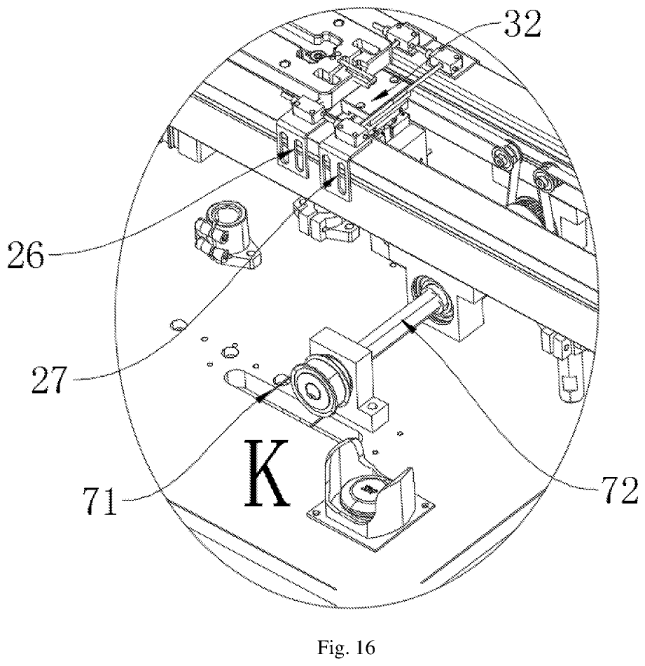

With reference to FIG. 1-16, the present invention discloses a pressure-retaining automata for voice-operated motherboard adhesive and SR, consisting of:

A rack (10); and

A belt line module (20) disposed on the rack (10); and

No. 1 sensor (21) set on the belt line module (20) to sense products; and

No. 2 sensor (22) set on the belt line module (20) to sense the first segment of products in place; and

No. 3 sensor (23) set on the belt line module (20) to sense products separating from the first segment; and

No. 4 sensor (24) set on the belt line module (20) to sense the second segment of products in place; and

No. 5 sensor (25) set on the belt line module (20) to sense products separating from the second segment; and

No. 6 sensor (26) set on the belt line module (20) to sense the third segment of products in place; and

No. 7 sensor (27) set on the belt line module (20) to sense products separating from the third segment; and

No. 8 sensor (28) set on the belt line module (20) to sense the fourth segment of products in place; and

No. 1 stop module (30) disposed on rack (10); and

No. 2 stop module (31) disposed on rack (10); and

No. 3 stop module (32) disposed on rack (10); and

No. 1 pressure-retaining module (40) disposed on rack (10); and

No. 2 pressure-retaining module (42) disposed on rack (10); and

No. 1 guide module (50) arranged on the rack (10) and located below No. 1 pressure-retaining module (40); and

No. 2 guide module (51) arranged on the rack (10) and located below No. 2 pressure-retaining module (42); and

A man-machine interface (60) set on the rack (10).

The No. 1 pressure-retaining module (40) is also installed with No. 1 pressure gauge (41) for pressure retention monitoring, and No. 2 pressure-retaining module (42) is also equipped with No. 2 pressure gauge (43) for pressure retention monitoring.

The man-machine interface (60) is equipped with a monochromatic lamp (61) for alarm display.

A pressure-retaining automata for voice-operated motherboard adhesive and SR further comprises:

A motor (7), fixed to the upper part of the rack (10);

A belt (71), one end of which is connected to the output end of the motor (7);

A driving shaft (72), one end of which is connected with the other end of the belt (71), so that the motor (7) drives the driving shaft (72) through the belt (71);

Wherein, the driving shaft (72) is connected with the belt line module (20).

A pressure-retaining automata for voice-operated motherboard adhesive and SR further comprises:

No. 1 guide module (50) and No. 2 guide module (51), disposed on the upper part of belt line module (20),

Wherein, the No. 1 guide module (50) and No. 2 guide module (51) are both connected to the cylinder.

A pressure-retaining automata for voice-operated motherboard adhesive and SR further comprises:

A cooling fan (11), arranged on the upper part of the rack (10) and playing a role in heat dissipation.

The working principle and use process of the present invention:

When operating in the positive direction, first preset the positive/automatic mode on the touch screen 60, the time required to maintain pressure of the No. 1 pressure-retaining module 40 and No. 2 pressure-retaining module 42, and the reference time as to whether simultaneous pressure retention is required for the No. 1 pressure-retaining module 40 and No. 2 pressure-retaining module 42. Put the product to be pressure retained, when the No. 1 sensor 21 detects an object and the other No. 3 sensor 23 to No. 8 sensor 28 detect no object, start the belt line 20. When the rising edge of the No. 2 sensor 22 detects it, the No. 1 stop module 30 is immediately started to allow the product to pass. The product moves forward. When the object triggers the No. 4 sensor 24, the No. 2 stop module 31 is activated immediately to release the product; the trailing edge of the No. 2 sensor 22 detects it, and has the No. 1 stop module 30 reset immediately;

The product keeps moving forward. When the object triggers No. 6 sensor 26, the guide module 51 is started immediately for positioning; the trailing edge of the No. 5 sensor 25 detects it, and the No. 2 stop module 31 is reset immediately. When the guide module 51 is positioned, and the value given by the No. 2 pressure gauge 43 for pressure retention monitoring meets the set value, the No. 2 pressure-retaining module 42 starts retaining pressure.

There are two situations at this time. For the first case, if there is no more product put in during the pressure-retaining period, once the pressure-retaining time is up, the guide module 51 and No. 2 pressure-retaining module 42 will be reset at the same time, and the No. 3 stop module 32 will release the product. The product keeps moving forward. When the object triggers No. 8 sensor 28 not to stop the movement of the belt 20, the product flows into the next station. Moreover, the trailing edge of the No. 7 sensor 27 detects it and resets No. 3 stop module 32 immediately. For the second case, products are put in during the pressure-retaining period. When the rising edge of the No. 2 sensor 22 detects it, the No. 1 stop module 30 is immediately started to allow the product to pass. The product moves forward. When the object triggers the No. 4 sensor 24 and meets the reference time of simultaneous pressure retention, the guide module 50 is started immediately for positioning. In addition, the trailing edge of the No. 3 sensor 23 detects it, and No. 1 stop module 30 is reset immediately. When the guide module 50 is positioned, and the value given by the No. 1 pressure gauge 41 for pressure retention monitoring meets the set value, the No. 1 pressure-retaining module 40 starts retaining pressure.

Once the pressure-retaining time of No. 2 pressure-retaining module 42 is up, the guide module 51 and No. 2 pressure-retaining module 42 will be reset at the same time, and the No. 3 stop module 32 will release the product.

The product keeps moving forward. When the object triggers No. 8 sensor 28 not to stop the movement of the belt 20, the product flows into the next station. Moreover, the trailing edge of the No. 7 sensor 27 detects it and resets No. 3 stop module 32 immediately. When the pressure-retaining time of No. 1 pressure-retaining module 40 expires, the guide module 50 and the No. 1 pressure-retaining module 40 are reset at the same time, and the No. 2 stop module 31 and the No. 3 stop module 32 are released.

The product keeps moving forward. When the trailing edge of the No. 5 sensor 25 senses it, the No. 2 stop module 31 is reset immediately. When the trailing edge of the No. 7 sensor 27 senses it, the No. 3 stop module 32 is reset immediately.

In the second case, if the reference time of simultaneous pressure retention is not satisfied, the No. 1 pressure-retaining module 40 and the guide module 50 will not operate., keep waiting till the pressure-retaining time of No. 2 pressure-retaining module 42 is up, then the guide module 51 and No. 2 pressure-retaining module 42 will be reset at the same time, and the No. 3 stop module 32 will release the product. The product keeps moving forward. When the object triggers No. 8 sensor 28 not to stop the movement of the belt 20, the product flows into the next station. Moreover, the trailing edge of the No. 7 sensor 27 detects it and resets No. 3 stop module 32 immediately. At this time, the No. 2 stop module 31 releases, the trailing edge of the No. 2 sensor 22 detects it, and has the No. 1 stop module 30 reset immediately. The product keeps moving forward. When the object triggers No. 6 sensor 26, the guide module 51 is started immediately for positioning; the trailing edge of the No. 5 sensor 25 detects it, and the No. 2 stop module 31 is reset immediately. When the guide module 51 is positioned, and the value given by the No. 2 pressure gauge 43 for pressure retention monitoring meets the set value, the No. 2 pressure-retaining module 42 starts retaining pressure. The first and second cases would be repeated in this way, so that the products are subject to pressure retention continuously over and over again. The whole process automatically completes the transportation, positioning, pressure retention and selection of pressure-retaining station of objects that require pressure retention, without manual operation. The machine has the characteristics of high positioning accuracy, accurate pressure-retaining time, high automation, high work efficiency, good product effects, and high rates of finished products. When operating in the reverse direction, it is just the opposite of the above operation steps, so it is not repeated herein.

Finally, it shall be noted that the above descriptions are only preferred embodiments of the present invention, and are not intended to limit the present invention. Although the present invention has been described in detail with reference to the foregoing embodiments, those skilled in the art may still modify the technical solutions described in the foregoing embodiments, or equivalently replace some of the technical features. Any modification, equivalent replacement, improvement, etc., made within the spirit and principle of the present invention shall be included in the protection scope of the present invention.

What is claimed is:

1. A pressure-retaining automata for voice-operated motherboard adhesive and SR consists of:
a rack (10); and
a belt line module (20) disposed on the rack (10); and
No. 1 sensor (21) set on the belt line module (20) to sense products; and
No. 2 sensor (22) set on the belt line module (20) to sense the first segment of products in place; and
No. 3 sensor (23) set on the belt line module (20) to sense products separating from the first segment; and
No. 4 sensor (24) set on the belt line module (20) to sense the second segment of products in place; and
No. 5 sensor (25) set on the belt line module (20) to sense products separating from the second segment; and
No. 6 sensor (26) set on the belt line module (20) to sense the third segment of products in place; and
No. 7 sensor (27) set on the belt line module (20) to sense products separating from the third segment; and
No. 8 sensor (28) set on the belt line module (20) to sense the fourth segment of products in place; and
No. 1 stop module (30) disposed on rack (10); and
No. 2 stop module (31) disposed on rack (10); and
No. 3 stop module (32) disposed on rack (10); and
No. 1 pressure-retaining module (40) disposed on rack (10); and
No. 2 pressure-retaining module (42) disposed on rack (10); and
No. 1 guide module (50) arranged on the rack (10) and located below No. 1 pressure-retaining module (40); and
No. 2 guide module (51) arranged on the rack (10) and located below No. 2 pressure-retaining module (42); and
a man-machine interface (60) set on the rack (10).

2. A pressure-retaining automata for voice-operated motherboard adhesive and SR according to claim 1, wherein the No. 1 pressure-retaining module (40) is also installed with No. 1 pressure gauge (41) for pressure retention monitoring, and No. 2 pressure-retaining module (42) is also equipped with No. 2 pressure gauge (43) for pressure retention monitoring.

3. A pressure-retaining automata for voice-operated motherboard adhesive and SR according to claim 2, wherein the man-machine interface (60) is equipped with a monochromatic lamp (61) for alarm display.

4. A pressure-retaining automata for voice-operated motherboard adhesive and SR according to claim 3, wherein it further comprises:
a motor (7), fixed to the upper part of the rack (10);
a belt (71), one end of which is connected to the output end of the motor (7);
a driving shaft (72), one end of which is connected with the other end of the belt (71), so that the motor (7) drives the driving shaft (72) through the belt (71);
wherein, the driving shaft (72) is connected with the belt line module (20).

5. A pressure-retaining automata for voice-operated motherboard adhesive and SR according to claim 4, wherein it further comprises:
No. 1 guide module (50) and No. 2 guide module (51), disposed on the upper part of belt line module (20),
wherein, the No. 1 guide module (50) and No. 2 guide module (51) are both connected to the cylinder.

6. A pressure-retaining automata for voice-operated motherboard adhesive and SR according to claim 5, wherein it further comprises:
a cooling fan (11), arranged on the upper part of the rack (10).
